(19) United States
(12) Patent Application Publication
(10) Pub. No.: US 2022/0012711 A1
(43) Pub. Date: Jan. 13, 2022

(54) ESTABLISHING A SHARED SESSION BETWEEN ENTITIES

(71) Applicant: ENTERSEKT INTERNATIONAL LIMITED, Ebene (MU)

(72) Inventors: Gerhard Gysbert OOSTHUIZEN, Stellenbosch (ZA); Daniël Deetlefs BESTER, Stellenbosch (ZA); Tertius WESSELS, Stellenbosch (ZA); Jonathan Daniel VAN DER MERWE, Stellenbosch (ZA); Mercia LE ROUX, Stellenbosch (ZA)

(21) Appl. No.: 17/309,274

(22) PCT Filed: Nov. 19, 2019
(86) PCT No.: PCT/IB2019/059917

§ 371 Date: May 13, 2021

(30) Foreign Application Priority Data
Nov. 19, 2018 (ZA) 2018/07753

(51) Int. Cl. G06Q 20/32; G06Q 20/40; G06Q 40/08; G06Q 30/02; G06F 16/245; H04L 9/32; H04L 29/08

(52) U.S. Cl. CPC G06Q 20/3276; G06Q 20/401; G06Q 20/3278; G06Q 40/08; G06Q 20/383; G06F 16/245; H04L 9/3226; H04L 67/141; G06Q 30/0226

(57) ABSTRACT

A system and method for establishing a shared session between entities is disclosed. In a method, a first shared session request message being associated with a tag identifier and a first device associated with a first entity is received. The first device is associated with a shared session associated with the tag identifier. A second shared session request message being associated with the tag identifier and a second device associated with a second entity is received. The second device is associated with the shared session. One or both of the first device and the second device having obtained the tag identifier from a tag provided by the first entity or the second entity. The shared session is configured for requesting and providing transaction-related data by and to at least one of the devices associated with the shared session.

### CROSS-REFERENCE TO RELATED APPLICATIONS

This application claims priority from South African provisional patent application number 2018/07753 filed on 19 Nov. 2018, which is incorporated by reference herein.

### FIELD OF THE INVENTION

This invention relates to a system and method for establishing a shared session between entities. Aspects of the disclosure may find application in processing payments without consumer intervention in respect of transactions conducted between the consumer and the merchant via the shared session.

### BACKGROUND TO THE INVENTION

Consumers are increasingly able to conduct transactions with merchants using their personal devices, such as mobile phones or wearable devices. Such transactions may make use of contactless communication interfaces, such as near field communication (NFC) or radio-frequency identification (RFID) interfaces or by either the consumer device or a merchant device capturing a graphical code.

For example, US20130054413A1 discloses a contactless payment system for merchant transactions (e.g., a restaurant) which comprises generating, at the contactless payment system, a total bill of purchases associated with a consumer, associating a unique identifier of a RFID tag or a quick response (QR) code with the total bill, transmitting the total bill and associated unique identifier to a consumer accessible payment network, and receiving payment from the consumer for satisfaction of the total bill. The consumer submits the payment using a contactless-enabled device, such as a smartphone. The contactless-enabled device may interrogate the RFID tag or read the QR code to receive the unique identifier and a payment network link. Furthermore, the contactless-enabled device submits a payment transaction request to the payment network, where the payment transaction request includes the unique identifier and an account identifier. The payment network receives the payment transaction request and locates the total bill using the unique identifier as a key.

However existing technological platforms may still require substantial interaction on the part of the consumer in order to initiate and/or complete payment in respect of the transaction. This consumer friction may be due to technical short comings associated with existing platforms and there is accordingly scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method comprising: receiving a first shared session request message being associated with a tag identifier and a first device associated with a first entity; associating the first device with a shared session associated with the tag identifier; receiving a second shared session request message being associated with the tag identifier and a second device associated with a second entity; and associating the second device with the shared session, wherein one or both of the first device and the second device having obtained the tag identifier from a tag provided by the first entity or the second entity, and wherein the shared session is configured for requesting and providing transaction-related data by and to at least one of the devices associated with the shared session.

Further features provide for associating the first device or the second device with the shared session to include initiating a shared session in association with the tag identifier and the first device or the second device; for the method to include validating the tag identifier received from the first device or the second device; and for validating the tag identifier to include checking a list or data structure for a matching tag identifier.

Yet further features provide for the tag identifier to be a cryptographic code configured for validation using a cryptographic process, and for validating the tag identifier to include using the cryptographic process to validate the tag identifier.

Still further features provide for the method to include receiving a first transaction request message, including the tag identifier, from one of the first device or the second device and transmitting a second transaction request message, including the tag identifier, to the other of the second device or the first device, for the second transaction request message to be based on the first transaction request message.

Even further features provide for the method to be conducted at a first device gateway in communication with a second device gateway via a communication network, for the first shared session request message to be a request to initiate the shared session, and for the method to include generating the tag identifier and transmitting the tag identifier to the first device.

Further features provide for the method to include assigning a first access code to the first device, and for the tag identifier and first access code to be transmitted to the first device in a shared session response message.

Yet further features provide for receiving the second shared session request message associated with the tag identifier to include receiving the second shared session request message from the second device via the second device gateway, for the second shared session request message to include the tag identifier and a second access code; and for the method to include storing the second access code in association with the tag identifier.

Still further features provide for the second device to have obtained the tag identifier from the tag provided by the first entity.

Even further features provide for the method to include transmitting a transaction request message to the second device gateway, the transaction request message including the tag identifier, the second access code and one or both of transaction request detail and transaction information detail; and for the transaction request message transmitted to the second device gateway to be based on a transaction request message received from the first device.

Still further features provide for the method to include receiving a transaction response message from the second device gateway, for the transaction response message to include one or both of information requested by way of the information request detail and a confirmation of actions initiated in respect of the transaction request detail.

Further features provide for the first entity to be a merchant and for the second entity to be a consumer.

Further features provide for the second shared session message to include a pre-authorisation confirmation including a pre-authorised limit; for the first shared session message to include a payment request including an amount in respect of the transaction, and for the method to include automatically initiating processing of the payment in respect of the amount without second entity intervention if the amount is within the pre-authorised limit; for the method to include prompting the second entity via the second device for authorisation to process the payment in respect of the amount if the amount exceeds the pre-authorised limit; and for prompting the second entity for authorisation to process the payment in respect of the amount to include transmitting an authorisation request message to the second device, the authorisation request message including the amount and being configured to prompt the second entity for authorisation to process the payment in respect of the amount.

Still further features provide for the pre-authorisation confirmation to be received in response to a second device gateway associated with the second device validating that the second entity is pre-authorised to conduct the transaction; for the pre-authorisation confirmation to be received from the second device gateway; and for the pre-authorisation confirmation to be received in response to the second device transmitting a shared session request message to the second device gateway, the shared session request message including the tag identifier and a device identifier which uniquely identifies the second device to the second device gateway.

Yet further features provide for receiving the pre-authorisation confirmation to precede initiation of the transaction between the second entity and the first entity; for receiving the pre-authorisation confirmation to precede any payment obligation by the second entity in favour of the first entity; and for the pre-authorisation confirmation to be devoid of any personal information associated with the second entity.

Further features provide for receiving the payment request to succeed initiation of the transaction between the second entity and the first entity; and for receiving the payment request to establish a payment obligation by the second entity in favour of the first entity.

Still further features provide for initiating processing of the payment in respect of the amount to include forwarding the payment request to the second device gateway instructing payment of the amount against a financial account associated with the second entity in favour of a financial account associated with the first entity; for processing the payment in respect of the amount to include accessing details of a financial account associated with the first entity and transmitting a payment instruction message to a second device gateway associated with the second device, the payment instruction message including the amount and details of the financial account associated with the first entity.

Other information may be requested and provided over the shared session, for example loyalty information, personal information and the like.

In accordance with a further aspect of the invention there is provided a system comprising: a processor and a memory configured to provide computer program instructions to the processor to execute functions of components; a shared session message component for receiving a first shared session request message being associated with a tag identifier and a first device associated with a first entity; an associating component for associating the first device with a shared session associated with the tag identifier; the shared session message component further being for receiving a second shared session request message being associated with the tag identifier and a second device associated with a second entity; and the associating component further being for associating the second device with the shared session, wherein one or both of the first device and the second device having obtained the tag identifier from a tag provided by the first entity or the second entity, and wherein the shared session is configured for requesting and providing transaction-related data by and to at least one of the devices associated with the shared session.

In accordance with a further aspect of the invention there is provided a computer program product comprising a computer-readable medium having stored computer-readable program code for performing the steps of: receiving a first shared session request message being associated with a tag identifier and a first device associated with a first entity; associating the first device with a shared session associated with the tag identifier; receiving a second shared session request message being associated with the tag identifier and a second device associated with a second entity; and associating the second device with the shared session, wherein one or both of the first device and the second device having obtained the tag identifier from a tag provided by the first entity or the second entity, and wherein the shared session is configured for requesting and providing transaction-related data by and to at least one of the devices associated with the shared session.

Further features provide for the computer-readable medium to be a non-transitory computer-readable medium and for the computer-readable program code to be executable by a processing circuit.

In accordance with a further aspect of the invention there is provided a computer-implemented method comprising: receiving a first shared session message being associated with a tag identifier and a first device, the tag identifier having been obtained by the first device associated with a first entity from a tag provided by a second entity, the tag being associated with a transaction to be conducted between the first entity and the second entity; initiating a shared session in association with the tag identifier and the first device; receiving, from a second device associated with the second entity, a second shared session message associated with the tag identifier; and if the tag identifier associated with the second shared session message matches the tag identifier associated with the shared session, associating the second device with the shared session, wherein the shared session is configured for requesting and providing transaction-related data by and to at least one of the devices associated with the shared session.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary system for establishing and transacting via a shared session according to aspects of the present disclosure;

FIG. 2 is a swim-lane flow diagram which illustrates operations performed by a merchant device gateway and a merchant device in an example method for establishing a shared session according to aspects of the present disclosure;

FIG. 3 is a swim-lane flow diagram which illustrates operations performed by a consumer device, consumer device gateway and merchant device in an example method for establishing a shared session according to aspects of the present disclosure;

FIG. 4 is a swim-lane flow diagram which illustrates an example pre-authorisation method according to aspects of the present disclosure;

FIG. 5 is a schematic diagram which illustrates aspects of the method of FIG. 3 from the perspective of a consumer;

FIG. 6 is a swim-lane flow diagram which illustrates an example method for conducting a transaction via a shared session according to aspects of the present disclosure;

FIG. 7 is a block diagram which illustrates exemplary components which may be provided by a system for establishing and transacting via a shared session according to aspects of the present disclosure; and,

FIG. 8 illustrates an example of a computing device in which various aspects of the disclosure may be implemented.

### DETAILED DESCRIPTION WITH REFERENCE TO THE DRAWINGS

The present disclosure provides a system and method for establishing a shared session between entities who wish to enter into a transaction. The shared session may be established by presentation of a tag identifier by one or more of the entities and acquisition and submission of that tag identifier by other entities. The tag identifier may for example be generated by or on behalf of one of the entities and obtained and subsequently presented by other entities. The tag identifier may be uniquely identifiable to the entity having created it and may be verifiable by that entity as being valid. In some implementations, the tag identifier may be created by a service provider who provides a shared session service to participating entities. The shared session may be established between respective devices of the entities, optionally via one or more server computers or device gateways of, e.g., the service provider. The shared session may be configured for requesting and providing transaction-related data by and to at least one of the devices associated with the shared session.

In some implementations, a shared session may be established between a first entity being a consumer and a second entity being a merchant. Aspects of the present disclosure may enable pre-authorisation of the consumer to transact with the merchant before any payment obligation is imposed on the consumer. Such pre-authorisation may be negotiated via the shared session with minimal to no intervention on the part of the consumer and may be confirmed by way of the shared session. The consumer may simply “check-in” at a merchant outlet and establish him/herself as being able to pay (by way of the pre-authorisation). Once the consumer has entered into a transaction with the merchant outlet and is under an obligation to make payment in respect of the transaction, the merchant outlet may be able to request that the payment be processed without any further interaction on the part of the consumer (subject to certain predefined conditions being met).

The shared session may initially be independent of any transaction, and may be a digital communication conduit via which entities can exchange data pursuant to entering into and completing a transaction. The shared session may provide an interactive digital communication channel between entities who may want to enter into a transaction with each other.

The shared session may be a communication channel that extends between a first entity device and a second entity device via appropriate device gateways and a communication network. The communication channel may be a secure channel. For example, the communication channel may be secured using TLS, SSL, IPSec or the like. Access to the shared session may be controlled by way of a tag identifier and access codes that are assigned to devices participating in the shared session. The access codes may be configured for use by the relevant gateway in restricting requests for access and/or information associated with entities participating on or joined to the shared session. The access codes may be configured for cryptographic validation by the relevant device gateway to ensure that a request received from another gateway is valid. The access codes may also facilitate routing of requests and responses transmitted between devices in the shared session. To this end, the access codes may include routing information usable by device gateways and/or a directory service in routing request and response messages.

According to some aspects of the disclosure, the consumer uses a consumer device to communicate digitally with a consumer device gateway (e.g. maintained by the service provider or a consumer network provided by his or her issuing financial institution) only, and not with a merchant device or an acquiring financial institution of the merchant. This may facilitate anonymous transacting on behalf of the consumer, in that the merchant outlet and its associated financial institution never have sight of any personal information associated with the consumer (unless approved by the user or logic or rules associated with a consumer record).

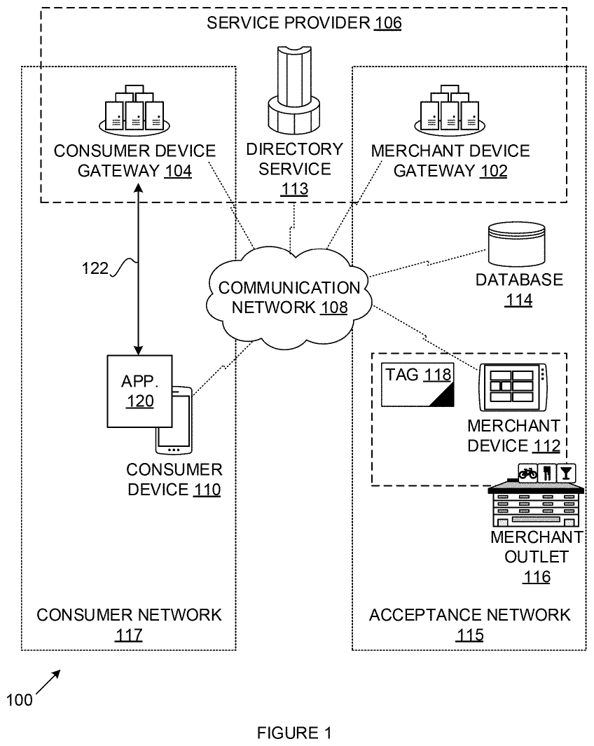

FIG. 1 is a schematic diagram which illustrates an exemplary system (100) for establishing and transacting via a shared session according to aspects of the present disclosure.

The system (100) may include a merchant device gateway (102) and a consumer device gateway (104). One or both of the merchant device gateway (102) and consumer device gateway (104) may be provided by a service provider (106). The service provider (106) may be a shared session service provider providing shared session services to entities such as consumers and merchants. In some cases, the same service provider may provide both gateways, while in other cases different service providers may provide the different gateways. In some cases, the consumer device gateway (104) may be maintained or operated by a financial institution associated with a consumer (e.g. a so-called issuing financial institution). The merchant device gateway (102) may be maintained or operated by or on behalf of the merchant outlet.

The system (100) may further include a communication network (108), a consumer device (110) associated with the consumer and a merchant device (112) associated with the merchant. The system (100) may include a directory service (113) which the gateways may use to identify each other (e.g. based on routing information included in a tag identifier).

The communication network (108) may be any appropriate network via which information, data and/or messages may be exchanged between respective devices. The communication network (108) may for example include one or both of public networks (e.g. the Internet) and private networks (such as internal local area networks, virtual private networks, proprietary payment processing networks and the like). In some cases, communication on the communication network (108) may be secured, for example using (optionally mutual) transport layer security (TLS), secure sockets layer (SSL), Internet Protocol Security (IPSec) or the like.

It should be appreciated that although only one of each of the consumer device gateway (104), merchant device gateway (102), merchant device (112) and consumer device (110) are illustrated, in a practical implementation there may be a plurality of each of these. The physical location of the consumer device gateway (104) and/or merchant device gateway (102) may be unknown and irrelevant to the entities making use of their functionality.

The merchant device gateway (102) may be provided by any suitable computing device, or network of computing devices, configured to perform a server role, such as one or more server computers.

The merchant device gateway (102) may be configured to communicate with one or both of the consumer device (110) and merchant device (112) to initiate and/or join shared sessions and/or to transact via shared sessions. In some implementations, the merchant device gateway (102) may be configured to communicate with the consumer device (110) via the communication network (108) directly, while in other implementations communications between the merchant device gateway (102) and consumer device (110) may be via the consumer device gateway (104).

The merchant device gateway (102) may be configured to maintain a suitable data structure (such as a table) in which a tag identifier can be stored. The tag identifier may be stored for matching with tag identifiers received from the consumer device (110) (e.g. via the consumer device gateway) or merchant device (112), as the case may be. Other information may be stored in the data structure in association with the tag identifier, such as merchant access codes, consumer access codes, attributes, transaction request detail, transaction information detail, consumer device gateway identifying and/or communication address information, a pre-authorised status, transaction status record and the like.

The merchant device gateway (102) may have access to a database (114) in which information and records may be stored and from which information and records may be accessed. In some implementations, a merchant record may be stored in the database (114). The merchant record may be associated with the merchant and may include information usable in making payments in favour of a financial account associated with the merchant.

The consumer device gateway (104) may be provided by any appropriate computing device or network of computing devices to perform a server role, such as one or more server computers.

The consumer device gateway (104) may maintain or have access to a financial account associated with the consumer and against which the consumer is able to conduct financial transactions. In some implementations, the consumer device gateway (104) may act as a gateway between the merchant device gateway (102) and the consumer device (110) via which communications between these respective devices may be transmitted.

The consumer device gateway (104) may have access to a consumer record. The consumer record may store or otherwise be associated with device identification data (such as a device identifier) which uniquely identifies the consumer device. The consumer record may be associated with the consumer financial account. The consumer record may include or reference one or more of personal information (such as names, national identity number, social security number, age, date of birth, driver's licence details, passport details, etc.); a billing address of the consumer; a shipping address of the consumer; loyalty data of various merchants (such as frequent flyer programme identifier, store loyalty programme identifier, etc.); health insurance data (such as a health insurance membership identifier, etc.); source of funds data, a pre-authorisation status and/or limit (in some cases specific to a particular merchant), a communication address associated with the consumer device, and the like.

Source of funds data include one or more of: payment card details (such as cardholder name, primary account number (PAN), expiry date, card verification value (CVV) or similar); tokenized payment card details (such as a tokenized PAN, expiry date and/or CVV, which may be issued to the software application by a token service and which may be dynamic) or other tokenization information (such as a limited use key, etc.); financial account details (e.g. account number, branch code, etc. for performing direct debit transactions); a cryptocurrency wallet address or similar data for performing cryptocurrency-based payments; an encryption key usable in identifying a source of funds; a cryptogram; an application cryptogram (AC) card key; an AC master key; a pointer to any of the foregoing (such as a consumer identifier and/or cryptographic pointer); and the like. Source of funds data may include or map to a consumer identifier which uniquely identifies the consumer to, e.g. the issuing financial institution. Source of funds data may thus be uniquely linked to the consumer and may identify the consumer to the issuing financial institution.

The consumer record may include information usable in identifying and authenticating the consumer device (110) via the communication network (108). For example, the consumer record may include information usable in validating the device identifier associated with the consumer record. The information may for example be one or more of a public key associated with a private key known only to the consumer device, an identifier uniquely associated with a digital certificate linked to the consumer device or the like.

Being able to uniquely identify and authenticate the consumer device (110), transmit and receive approval request and approval response messages to the consumer device and having access to the consumer record may enable the consumer device gateway to receive and process transaction request messages and generate and transmit suitable transaction response messages. Further, access to financial account and/or source of funds data may enable the consumer device gateway (104) to pre-authorise payments to be made against the consumer account in favour of a financial account associated with the merchant.

The consumer device gateway (104) may instantiate, maintain and destroy a data structure used for establishing, joining and transacting on a shared session. The data structure may store or otherwise be associated with a tag identifier, a consumer access code assigned to the tag identifier, attributes, transaction request detail, transaction information detail, merchant device gateway identifying and/or communication address information, a pre-authorised status and the like.

In the embodiment illustrated with reference to FIG. 1, the merchant device gateway (102) and consumer device gateway (104) are provided by separate computing devices. The merchant device gateway may for example form a part of an acceptance network (115) that facilitates financial transaction acceptance by or on behalf of the merchant. The consumer device gateway may for example form a part of a consumer network (117) provided by an issuing financial institution. In other embodiments, the consumer device gateway and merchant device gateway may be provided by a single computing device (or a series of logically associated computing devices, such as a cluster of server computers, etc.). The merchant device gateway and consumer device gateway may for example be provided by software components executing on the same computing device, which computing device may be maintained by the service provider (106). It should therefore be appreciated that in some embodiments, communication between the gateways may be over the communication network (108) while in other embodiments communication between the gateway may be via, for example, an enterprise services bus or similar arrangement which implements a communication system between mutually interacting software applications in a service-oriented architecture.

The consumer device gateway and merchant device gateway may be configured to receive shared session request messages and transmit shared session response messages. The consumer device gateway may receive shared session request messages from and may transmit shared session response messages to one or both of the consumer device and merchant device gateway. The merchant device gateway may receive shared session request messages from and may transmit shared session response messages to one or both of the merchant device and consumer device gateway.

The consumer device gateway and merchant device gateway may further be configured to receive transaction request messages and transmit transaction response messages. The consumer device gateway may receive transaction request messages from and may transmit transaction response messages to one or both of the consumer device and merchant device gateway. The merchant device gateway may receive transaction request messages from and may transmit transaction response messages to one or both of the merchant device and consumer device gateway.

The consumer device (110) may be any appropriate computing device configured to communicate on the communication network (108). The consumer device (110) may be a portable or mobile computing device, such as a mobile phone, tablet computer, wearable computing device, personal digital assistant or the like. The consumer device (110) may be registered with one or both of the service provider (106) and the consumer device gateway (104) to enable the service provider (106) and/or consumer device gateway (104) to uniquely identify and authenticate the consumer device (110) via the communication network (108). The consumer device (110) may securely store a private key which may be usable in signing or encrypting information (such as a nonce) for transmission to the consumer device gateway (104) for uniquely identifying and authenticating the consumer device (110) via the communication network (108). In some implementations, messages transmitted from the consumer device may be signed or encrypted using the private key for validation by the consumer device gateway. The consumer device (110) may include a software application (120) which may provide some or all of the functionality attributed herein to the consumer device. In some implementations, there may be a link (122) between the software application (120) and the consumer device gateway (104). In some implementations, the consumer device may securely store source of funds data.

The merchant device (112) may be provided by any suitable computing device. In some cases, the merchant device (112) may provide a point-of-sale functionality. In some implementations, the merchant device (112) may be physically located at a merchant outlet (116) associated with the merchant. In other implementations (e.g. e-commerce-type implementations), the merchant device may be a server computer which is logically associated with the merchant. The merchant outlet (116) may for example be a bricks-and-mortar outlet from which the merchant purveys goods and/or services to the consumer. The merchant device (112) may be configured to communicate with the merchant device gateway (102) via the communication network (108).

The system (100) may also include a tag (118). In some implementations, the tag may be a static tag which may for example be physically located and displayed at the merchant outlet (116). In other implementations, the tag may be displayed via the merchant device and may for example be dynamic. The tag (118) may be associated with a tag identifier. In some cases, the tag and/or tag identifier may be dynamically generated for, and unique to, each transaction that the merchant device enters into. The tag (118) may be configured to provide the tag identifier to one or both of the consumer device (110) and the merchant device (112). The tag (118) may provide the tag identifier via any appropriate proximity-based communication interface, such as near field communication, near sound communication, optical communication (e.g. via a graphical code) or the like. In some cases, the tag (118) may be a virtual tag provided by, for example, the merchant device.

The tag identifier may be a globally unique identifier (GUID) or may be unique only to the merchant and, in conjunction with a merchant identifier, globally unique. The tag identifier may include information usable in identifying the merchant device gateway (e.g. information usable by the directory service (113) in identifying the merchant device gateway). In some implementations, the tag identifier may be a cryptographic code configured for validation by the merchant device gateway and usable in asserting any number of claims. The tag identifier may be cryptographic code and may be configured for validation by a cryptographic process. The tag identifier may for example be digitally signed for validation by a cryptographic process that validates digitally signed messages. In some implementations, the tag identifier may be signed using a JSON Web Signature and the tag identifier may be a JSON Web Token, which is an Internet standard for creating JSON-based access tokens that assert some number of claims. The tag identifier may for example be signed by one party's private key (e.g. that of the merchant device gateway), so that all parties (already being, by some suitable and trustworthy means, in possession of the corresponding public key) are able to verify that the token is legitimate by way of a cryptographic process using the public key. Example cryptographic processes include decryption with a predetermined cryptographic key, a digital signature validation process and the like.

In some implementations, the merchant device (112) may incorporate the tag (118). In other words, the tag (118) may be a part of or may be provided by the merchant device (112). In other implementations, the tag (118) and merchant device (112) may be separate devices. The tag (118) may be passive in that it only provides the tag identifier for accessing by the consumer device (110), while in other implementations the tag (118) may be an active tag which can exchange data and/or information with the consumer device (110) and/or the merchant device (112).

In some cases, the merchant outlet (116) may include a number of tags (118). For example, in one exemplary implementation, the merchant outlet (116) may be a restaurant at which each table has a tag (118) associated therewith. In another exemplary implementation, the merchant outlet may be a store, supermarket or the like with multiple merchant devices (112) each of which is associated with and/or provides a tag (118). In another exemplary implementation, the merchant outlet (116) may be an online merchant outlet in the form of a merchant website, which may provide a tag and tag identifier to each new visitor accessing the website.

The merchant device (112) may thus be able to generate or access the tag identifier and provide it for access by the consumer device (110). The consumer device (110) may obtain the tag identifier and submit it to the consumer device gateway (104). The consumer device gateway (104) may analyse the tag identifier (which may, e.g. include identifying the source merchant) and record the consumer as being associated with the transaction and willing to interact with the merchant. In some implementations, the consumer device gateway (104) may notify the merchant device (112) that a willing consumer exists (so that they know that a consumer is available, together with some session indicator).

At some stage the merchant may wish to initiate/complete/augment a transaction with the consumer device (e.g. get payment details, get loyalty information, get user details) and the merchant device may submit the tag identifier and relevant request to the consumer network (104). The consumer device gateway (104) may determine whether a valid consumer is available (i.e. code has been scanned) and if the session is valid. In some cases, the consumer network may request consent from the consumer device (e.g. if amount is over USD50, or if this is a request for personal information).

The consumer device (110) may receive the request for and may obtain consent to the specific event (e.g. based on configuration/preferences) and may also be informed of information shared. The consumer device gateway (104) may retrieve and return requested information (e.g. personal information, loyalty card or payment card details) to the merchant device (112). This could include taking some action or creating cryptogram/signature providing consent. The merchant device may then use the retrieved information in subsequent transactions (e.g. register user for loyalty, submit financial transaction containing additional information). It should be appreciated that multiple requests should be made.

The system (100) described above may implement methods for establishing and transacting a shared session. Some example methods which may be implemented using the above system are described below.

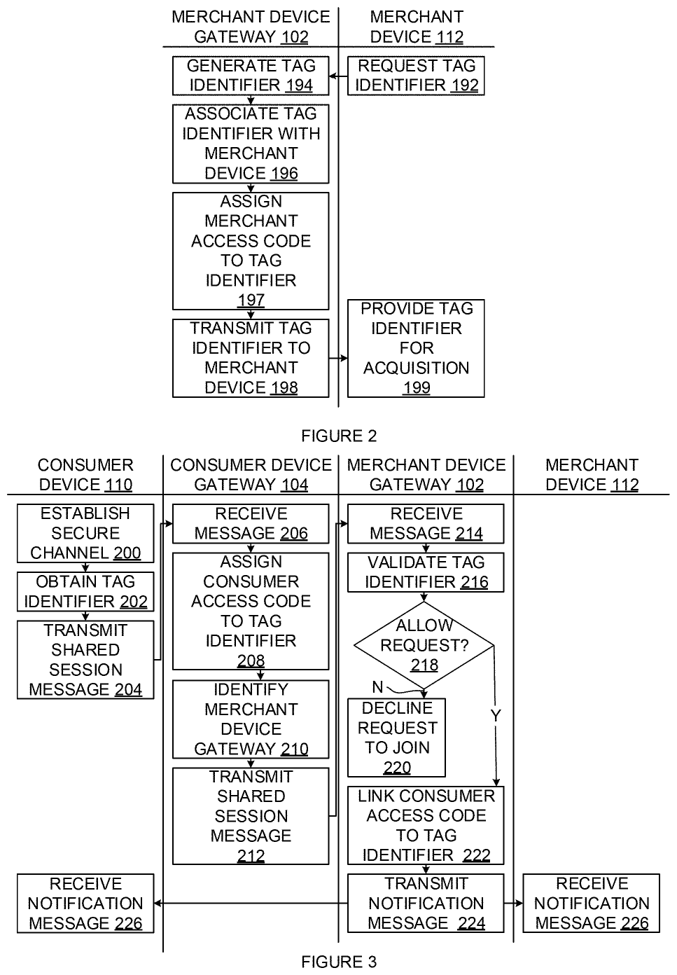

FIG. 2 is a swim-lane flow diagram which illustrates operations performed by a merchant device gateway and a merchant device in an example method for establishing a shared session according to aspects of the present disclosure. Respective swim-lanes in the swim-lane flow diagram of FIG. 2 delineate steps, operations or procedures performed by respective entities or devices. It should be appreciated that in other embodiments, steps, operations or procedures may be performed by different entities or devices.

In the embodiment illustrated in FIG. 2, the merchant device (112) requests (192) a tag identifier. The merchant device may request the tag identifier by transmitting a tag identifier request message. The merchant device (112) may request the tag identifier by transmitting a shared session request message which requests a tag identifier. The message may be transmitted to a merchant device gateway (102) via a communication network. The message may include a merchant device identifier, a merchant device communication address, attributes of or detail pertaining to the merchant device (such as location, etc.) and the like. The request may be for a transaction-specific tag identifier. A transaction-specific tag identifier may be a tag identifier that uniquely identifies a transaction to which the merchant device is to be party. The merchant device requesting the tag identifier may constitute a request for establishment of a shared session for devices to join.

The merchant device gateway (102) may receive the request from the merchant device. The request may be received in a tag identifier request message from the merchant device (112) via the communication network. As mentioned, the tag identifier request may be received in a shared session request message or tag identifier request message.

The merchant device gateway (102) may generate (194) or obtain a tag identifier. This may include adding the tag identifier to a list of active tag identifiers and/or instantiating a data structure associated with the tag identifier. The merchant device gateway (102) may associate (196) the tag identifier with the merchant device. This may include linking a merchant device identifier to the tag identifier in the data structure. Other information received in or with the request from the merchant device may be stored in the data structure. The tag identifier may be associated with a time to live, after expiry of which the tag identifier may be removed from the list of active tag identifiers and/or from any data structures in which it is stored.

The merchant device gateway (102) may access or generate a merchant access code and assign (197) it to the tag identifier and/or merchant device identifier. The merchant access code may be associated with a time to live, which may be linked to a time to live of the tag identifier. The merchant access code may be a unique code usable in controlling access to the data structure and/or other information associated with the tag identifier. In some implementations, the merchant access code may be a cryptographic code (such as a JSON web token, or the like) configured for validation by the merchant device gateway and usable by the merchant device in asserting any number of claims. The merchant device gateway may link the merchant access code to the tag identifier and/or merchant device, for example by storing the merchant access code in the data structure linked to the tag identifier and/or a merchant device identifier. The merchant access code may be under the control of the merchant device gateway and may be configured for revocation and/or discontinuation at the instruction of the merchant device gateway.

The merchant device gateway (102) may transmit (198) the tag identifier and/or merchant access code to the merchant device. The tag identifier and/or merchant access code may be transmitted in a shared session response message. The merchant device (112) may receive and store the tag identifier and/or merchant access code.

The steps of generating or obtaining the tag identifier and merchant access code may constitute establishing by the merchant device gateway a shared session that can be joined by other entities submitting the tag identifier to the merchant device gateway. The merchant device may be joined to the shared session. That the merchant device is joined to the shared session may be recorded by associating the merchant access code to the tag identifier and sharing it with the merchant device.

The merchant device (112) may provide (199) the tag identifier for acquisition. Providing the tag identifier for acquisition may include outputting the tag identifier for capture by a consumer device (110). Providing the tag identifier may include transmitting the tag identifier to the tag (118) for output or transmission to a consumer device (e.g. in the case of an NFC or RFID tag). The tag (118) may be configured to provide the tag identifier to the consumer device (110) via one or more appropriate proximity-based communication techniques. The tag (118) may for example be an NFC or RFID enabled tag which provides the tag identifier to the consumer device (110) in response to interrogation by the consumer device (110). In some cases, the tag (118) may be or may display a graphical code, such as a quick response (QR) code, barcode, etc. for capturing by a camera associated with the consumer device (110). In some implementations, to initiate obtaining of the tag identifier, the consumer may simply locate the consumer device (110) proximate the tag (118). In an e-commerce scenario, the tag may be provided upon the consumer accessing the merchant's website, navigating to a checkout page, initiating a software application provided by the merchant and installed on the consumer device (110) or the like.

The method described above with reference to FIG. 2 describes an embodiment in which a shared session is established by the merchant device requesting a tag identifier from the merchant device gateway.

In other embodiments, however, the merchant device may obtain the tag identifier from the tag and transmit the tag identifier to the merchant device gateway (102). The tag may for example be a passive tag. The tag identifier may be transmitted to the merchant device gateway in a shared session request message. The shared session request message may be a request to join a shared session associated with the tag identifier or a request to establish a shared session with the tag identifier.

The merchant device gateway (102) may receive the shared session request message including the tag identifier. The merchant device gateway (102) may validate the tag identifier received in the shared session request message received from the merchant device (112). Validating the tag identifier may include performing an operation on the tag identifier to establish the validity thereof.

Validation may include querying a list and/or data structure for a matching tag identifier. Validating the tag identifier may include correlating the locally stored tag identifier having been received from the consumer device gateway (104) against the tag identifier received from the merchant device (112). If the tag identifier received in the shared session request message received from the merchant matches the stored tag identifier, the merchant device gateway (102) may add or join the merchant device (112) to the shared session. Otherwise, if the tag identifier does not match a stored tag identifier, the merchant device gateway may establish a shared session, for example by adding the tag identifier to a list and/or instantiating a data structure associated with the tag identifier.

In either case, the merchant device gateway may associate the tag identifier with the merchant device and may assign a merchant access code to the tag identifier. The merchant device gateway may transmit the merchant access code to the merchant device. The merchant access code may be transmitted to the merchant device in a shared session response message, and the merchant device may thus be joined to the shared session. The merchant device may receive and store the merchant access code, for example in association with the tag identifier.

Operations for joining a merchant device to a shared session are described above. Referring now to FIG. 3, an example method for joining a consumer device to the shared session is described. Respective swim-lanes in the swim-lane flow diagram of FIG. 3 delineate steps, operations or procedures performed by respective entities or devices. It should be appreciated that in other embodiments, steps, operations or procedures may be performed by different entities or devices. Aspects of the method as they may be perceived from the perspective of a consumer are illustrated in FIG. 5.

At some stage the consumer device (110) may obtain and submit the tag identifier as part of a request to join a shared session with the merchant or merchant device. The consumer may for example launch an application (120) on the consumer device (110). The application may establish (200) a secure communication channel with the consumer device gateway (104), e.g. using SSL,

TLS or the like. Establishing the secure communication channel may include the consumer device proving its identity to the consumer device gateway (104). The consumer device may transmit a device identifier to the consumer device gateway (104).

The device identifier may for example be in the form of a nonce signed by the consumer device (110) using a private key securely stored therein. The nonce may have been received from the consumer device gateway (104) as a part of the establishment of a secure communication channel between the consumer device (110) and the consumer device gateway (104). The device identifier may be configured for validation by the consumer device gateway (104), where successful validation (e.g. successful decryption using the public key corresponding to the private key) confirms the identity and authenticity of the consumer device (110). Validation may for example allow the consumer device gateway to consider with a high degree of confidence that the message has been received from a specific consumer device which is associated with a specific consumer financial account.

The consumer device gateway (104) may receive and validate the device identifier. Validating the device identifier may include performing an operation on the device identifier which confirms the identity and authenticity of the consumer device (110). The device identifier may for example be a nonce having been signed by the consumer device using a private key associated therewith and validating the identifier may include decrypting the nonce using the corresponding public key. As the private key is securely stored in the consumer device (110) and known only to the consumer device (110), successful decryption of the nonce (and in some cases validation of the nonce itself) may confirm the identity and authenticity of the consumer device (110). In other words, because decryption was possible with a public key uniquely associated with the consumer record, the consumer device gateway (104) may be able to establish the message as having been received from a consumer device (110) uniquely associated with that record.

The consumer device (110) may obtain (202) the tag identifier from the tag (118). Obtaining the tag identifier may use one or more of a contactless element, camera and microphone of the consumer device (110). In some implementations, the consumer device (110) may be configured to automatically detect the presence of the tag (118) and to obtain the tag identifier without consumer input. Obtaining (202) the tag identifier may for example be performed as a background operation which is not directly perceivable to the consumer. In other implementations, the consumer controls the consumer device (110) to obtain the tag identifier.

The consumer device (110) may transmit the tag identifier to the consumer device gateway (104). In the embodiment described with reference to FIG. 3, the consumer device (110) may transmit (204) the tag identifier to the consumer device gateway (104) in a shared session request message. The shared session request message may include the device identifier which uniquely identifies the consumer device (110) to the consumer device gateway (104) and the tag identifier. The shared session request message may be a request to join or establish a shared session.

The consumer device gateway (104) may receive (206) the tag identifier from the consumer device (110). The tag identifier may be received in a shared session request message.

The consumer device gateway (104) may assign (208) a consumer access code to the tag identifier and/or device identifier. The consumer device gateway (104) may for example maintain a data structure in a database. Assigning the consumer access code may include linking the consumer access code to one or more of the device identifier, the tag identifier and the consumer record. Assigning the consumer access code may include generating a unique access code and storing it in a data structure together with the tag identifier. The consumer access code may be associated with a time to live, which may be linked to a time to live of the tag identifier. The consumer access code may be a unique code (such as a GUID) usable in controlling access to one or more of the data structure, tag identifier, consumer record (or requests for information stored in the consumer record) and associated data. The consumer access code may be used to control and/or filter requests for information from other entities, such as the merchant device gateway. In some implementations, the consumer access code may be a cryptographic code (such as a JSON web token, or the like) configured for validation by the consumer device gateway using a cryptographic process and usable by the merchant device gateway in asserting any number of claims (e.g. you have previously provided me with this code and I can use it to request this data from you). The consumer access code may be under the control of the consumer device gateway and may be configured for revocation and/or discontinuation at the instruction of the consumer device gateway.

The consumer device gateway (104) may identify (210) the merchant device gateway (102) and/or the merchant device (112). The consumer device gateway may for example use a directory service to identify the merchant device gateway. The tag identifier may for example include a merchant identifier which can be used by the consumer device gateway and/or directory service to identify the merchant device gateway (102). The consumer device gateway (104) may analyse the tag identifier to determine its validity and, in some cases, to identify the merchant and/or merchant device gateway.

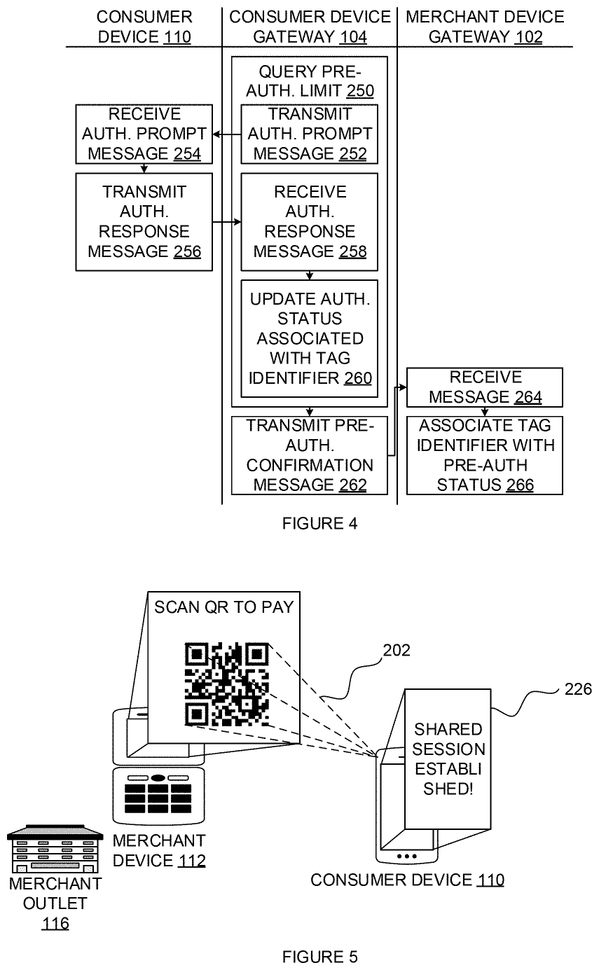

In some implementations, the consumer device gateway may at this stage initiate a pre-authorisation procedure (for example as described herein with reference to FIG. 4).

The consumer device gateway (104) may transmit (212) a shared session request message to the merchant device gateway (102). The shared session request message may include one or more of the tag identifier, the consumer access code and attributes describing consumer participation in the transaction. The attributes may for example be a list of data types that are available for sharing with the merchant device gateway, such as source of funds data, personal information categories (such as name, address, health data, etc.) loyalty details and the like. In some embodiments, the consumer device gateway (104) may include a pre-authorisation confirmation message or status in the shared session request message transmitted to the merchant device gateway. The shared session request message may be a request to join or initiate a shared session.

The merchant device gateway (102) may receive (214) the shared session request message and optionally the pre-authorisation confirmation message. The messages may be received from the consumer device gateway (104) and may be associated with the tag identifier having been obtained by the consumer device (110) from the tag (118). The pre-authorisation confirmation message may be received in response to the consumer device gateway (104) associated with the consumer device (110) validating that the consumer is pre-authorised to conduct the transaction, at least up to the pre-authorised limit.

The merchant device gateway (102) may validate (216) the tag identifier. Validating (216) the tag identifier may include performing a cryptographic operation on the tag identifier in order to verify its validity. Validating the tag identifier may include querying a database for a list of active tag identifiers, data structures being associated with the tag identifier or the like. Validating (216) the tag identifier may include verifying that the tag identifier is still valid (e.g. checking that the time to live has not expired). If the tag identifier is not valid, the process may terminate and an appropriate message may be sent to the consumer device gateway (104).

If the tag identifier is valid, the merchant device gateway (102) may determine (218) whether or not to allow the consumer to join or initiate a shared session with the merchant. This determination may be performed by comparing attributes included in the shared session request message received from the consumer device with required attributes associated with the tag identifier. For example, if the attributes included in the shared session request message are deficient, the merchant device gateway may decline (220) the consumer's request to join the shared session. Otherwise, the merchant device gateway may allow the consumer to join or establish the shared session and may link (222) the consumer access code to the tag identifier. Linking the consumer access code to the tag identifier may include updating a data structure associated with the tag identifier to include the consumer access code. Linking the consumer access code to the tag identifier may include storing a communication address or consumer device gateway identifier for routing messages to the consumer device via the consumer device gateway.

If the shared session has not already been established at the request of the merchant, the merchant device gateway (102) may thus establish a shared session. Establishing the shared session may include joining the consumer device (110) as a participant in or on the shared session, with the possibility of other participants being added too. The shared session may be configured for requesting and providing transaction-related data by and to at least one of the devices associated with the shared session. The shared session may enable information and/or data exchange between the consumer and the merchant. As the shared session is established via the merchant device gateway (102) and/or the consumer device gateway (104), the consumer may be able to (or may choose to) remain anonymous to the merchant (or other entities who may join the session) during the shared session. In some implementations, establishing the shared session may include recording the consumer as being associated with the tag identifier and being willing to interact with others associated with the tag identifier.

If the shared session has already been initiated (e.g. at the request of the merchant device or as described above with reference to FIG. 2), the consumer device may be joined to the shared session.

The merchant device gateway (102) may transmit (224) notification messages to devices joined to the shared session, for example to the consumer device (optionally via the consumer device gateway) and the merchant device. The notification messages may be shared session response messages. The notification messages may indicate that the session has been established and/or that the relevant entity/device has been joined or added to the shared session. The notification may include a session indicator and may indicate that a willing consumer (or other entity) has joined the session. The relevant device, in the illustrated embodiment being the merchant device and consumer device, may receive (226) and display the notification message.

The consumer may now be in a joint session with the merchant where various messages can be exchanged without necessarily disclosing the consumer's identity. Once the tag identifier has been associated with a pre-authorised status and/or once a shared session has been established between the consumer and the merchant, one or more of a number of processes may follow. For example, and as elaborated on below, once the “check-in” has been effected, or the shared session established, the merchant may be able to issue a payment request, loyalty identifier request, loyalty enrollment request, personal information request or the like.

For example, in some cases, the merchant device (112), knowing that the tag identifier has been provided to the consumer, may initiate an information exchange with the consumer device (110), via the merchant device gateway (102) and/or consumer device gateway (104). The information exchange may be via the shared session and may be referred to as a transaction which may be conducted by way of request and response messages. An exemplary exchange includes requesting and receiving from the consumer device (110) a loyalty identifier which uniquely identifies the consumer to the merchant for the purpose of awarding and tracking loyalty points by the merchant. In other cases, the merchant device (112) may initiate a loyalty enrollment process by way of which a loyalty identifier is generated and assigned to the consumer/consumer device (110). In some cases, health data may be exchanged. In some cases, the consumer's age may be requested and provided. It should be appreciated that various applications may be implemented.

As mentioned above, in some implementations, a pre-authorisation process may be implemented by way of which the consumer can pre-authorise a specific amount in respect of a transaction before entering into the transaction. FIG. 4 is a swim-lane flow diagram which illustrates an example pre-authorisation method according to aspects of the present disclosure. Respective swim-lanes delineate steps, operations or procedures performed by respective entities or devices. It should be appreciated that in other embodiments, steps, operations or procedures may be performed by different entities or devices.

The consumer device gateway (104) may query (250) a pre-authorisation limit associated with the device identifier. Querying (250) may be in response to receiving a shared session request message from the consumer device or from the merchant device gateway. The pre-authorisation limit may for example be based on information associated with the consumer record and/or consumer financial account, such a credit score, consumer approval and the like. In some implementations, the pre-authorisation limit may be stored in the consumer record and may be configurable by the consumer within limits. The pre-authorisation limit may specify an amount in respect of a payment under which consumer authorisation or approval is not required. In other words, payments for amounts below the pre-authorisation limit may be processed automatically without input from the consumer.

In some implementations, a transaction specific pre-authorisation limit may be established, in which case querying (250) the pre-authorisation limit may include prompting the consumer for pre-authorisation and/or a limit associated with the pre-authorisation. Prompting the consumer may include the consumer device gateway (104) transmitting (252) an authorisation prompt message to the consumer device (110). The consumer device (110) may receive (254) the authorisation prompt message and display an authorisation prompt to the consumer via a display of the consumer device (110). The consumer may review the prompt and input a confirmation or denial of the authorisation or a pre-authorisation limit associated with a maximum transaction value. The consumer device (110) may transmit (256) an authorisation response message including the authorisation confirmation or denial and/or a pre-authorisation limit. The consumer device gateway (104) may receive (258) the authorisation response message and may update (260) an authorisation status associated with the device identifier and/or tag identifier. The authorisation status may for example be one of pre-authorised or not pre-authorised, and in the case of pre-authorised may include the pre-authorisation limit. Updating (260) the authorisation status may include saving the pre-authorisation locally at the consumer network (104). In the illustrated embodiment, the consumer device gateway transmits (262) a pre-authorisation confirmation message to the merchant device gateway (102) which receives (264) the message and updates the data structure associated with the tag identifier to indicate that a pre-authorisation confirmation associated with the tag identifier has been received. The pre-authorisation confirmation message may include one or more of: the tag identifier, the pre-authorisation limit, the device identifier, consumer access code, a communication address via which communication can be established with the consumer device (110), a reference number uniquely identifying the message and/or the consumer device gateway (104), and the like.

It should be appreciated that at this stage, the pre-authorisation confirmation message may be associated with a transaction that is yet to be conducted between the merchant and the consumer associated with the consumer device (110). The message is thus associated with a prospective transaction in respect of which there is not yet any obligation on the consumer to make any payment in favour of the merchant. Arrival of the pre-authorisation confirmation message at the merchant device gateway (102) may therefore precede actual initiation of the transaction between the consumer and the merchant. It should also be appreciated that the pre-authorisation confirmation message may be devoid of any personal information associated with the consumer. The consumer may therefore be anonymous to the merchant device gateway (102).

The merchant device gateway (102) may associate (266) one or more of the shared session, tag identifier and consumer access code with a pre-authorised status. This may include storing or updating the data structure to store the tag identifier in association with a pre-authorised status and optionally some or all of the information included in the associated pre-authorisation confirmation message. The tag identifier may be stored in a data structure in association with a pre-authorised status, which storage may be associated with a time to live (e.g. a number of seconds or minutes). That is, the storage may be temporary. Storing the tag identifier in association with a pre-authorised status may include storing the pre-authorised limit in association with the tag identifier. Storing the tag identifier in association with the pre-authorised status may indicate that the consumer at the merchant outlet is able and willing to make payment up to the pre-authorised limit. Associating (266) the tag identifier with the pre-authorised status may confirm that the consumer is present and ready to enter into (or initiate) a transaction with a merchant who may yet to be identified. Associating (266) the tag identifier with the pre-authorised status may have the effect of confirming the consumer's intent to establish a shared session with the merchant from which the tag identifier was obtained and over which shared session various information exchanges (or transactions) between the consumer and merchant may occur. Exchanges over the shared session may occur without the consumer needing to disclose his or her identity to the merchant. From the perspective of the merchant, the exchanges occur between the merchant device (112) and the individual who has obtained the tag identifier provided by the merchant.

It should be appreciated that in some cases, the same tag identifier may be received in, or in association with, multiple pre-authorisation confirmation messages. For example, with reference to the exemplary restaurant scenario, there may be multiple consumers at the same table and who have hence obtained the same tag identifier from the tag (118) associated with the table.

In such a case, the merchant device gateway (102) may associate the same tag identifier with each of the pre-authorised statuses. This may include providing a data structure for each consumer access code, storing pre-authorised status indications in association with relevant data structures, and linking each of these data structures to the tag identifier. Each pre-authorised status may be linked to a consumer in respect of whom the corresponding pre-authorisation confirmation message was received. Linking may for example be by way of a reference number which may address the relevant consumer device gateway (104) from which the pre-authorisation confirmation message was received.

In some implementations, the merchant device (112) may transmit a notification to the consumer device (110) to notify the consumer that he or she has checked into the merchant outlet (116) and that payments in respect of amounts being less than the pre-authorised limit may be processed automatically without consumer intervention.

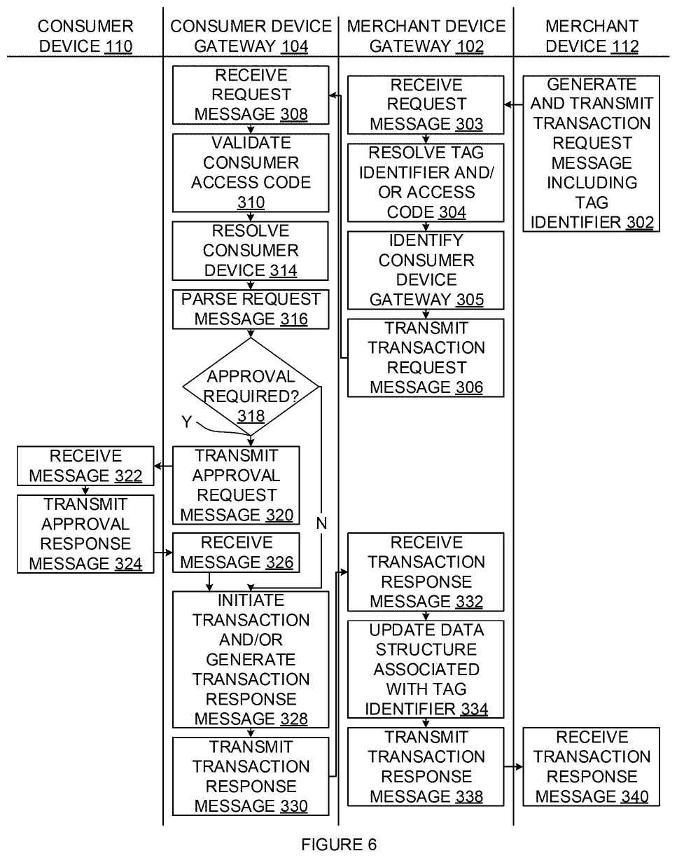

FIG. 6 is a swim-lane flow diagram which illustrates an example method for conducting a transaction via the shared session. The transaction may be an information exchange between the consumer device and the merchant device via the shared session. The information exchange may be a bidirectional information exchange. The transaction may be a financial transaction (e.g. requesting and authorising payment for goods/services). Respective swim-lanes delineate steps, operations or procedures performed by respective entities or devices. It should be appreciated that in other embodiments, steps, operations or procedures may be performed by different entities or devices.

The merchant device (112) may generate and transmit (302) a transaction request message. The message request may be transmitted to the merchant device gateway (102) and may include one or more of the tag identifier, merchant access code, transaction request detail (being details of information or actions required in order to advance the transaction, such as submitting a payment instruction to a payment network, requesting source of funds data, a list of the type of personal information required, loyalty detail requested, or the like) and transaction information detail (being information about the transaction that is to be conducted or advanced, such as an amount in respect of the transaction, detail on the goods/services to which the transaction relates, merchant detail (name, location, etc.), and the like). In some cases, the transaction request message and shared session request message may be one and the same message. In some implementations, the transaction request message may be a payment request message.

The merchant device gateway (102) may receive (303) the transaction request message including one or more of the tag identifier, the merchant access code, transaction request detail and transaction information detail. The transaction request message may be received from the merchant device (112).

The merchant device gateway (102) may resolve (304) the tag identifier and/or access code. The merchant device gateway may for example identify a data structure associated with the tag identifier and/or merchant access code. The merchant device gateway may validate the merchant access code against a merchant access code stored in the data structure to verify that the merchant device is permitted to transact against the tag identifier. Validating the merchant access code may determine whether or not the merchant device is joined to the shared session.

The merchant device gateway (102) may identify (305) the consumer device gateway. This may include identifying a communication address or consumer device gateway in the data structure linked to the tag identifier. Identifying the consumer device gateway may include using a directory service.

The merchant device gateway (102) may parse the transaction request message and construct an appropriate transaction request message for transmission to the consumer device gateway. Parsing the merchant device transaction request message may include evaluating one or both of the transaction request detail and the transaction information detail. Constructing the transaction request message may include generating a message including one or more of the transaction request detail, transaction information detail, consumer access code, tag identifier and the like. In some implementations, the merchant device gateway (102) may augment or add to the transaction request detail or transaction information detail when constructing the merchant device gateway transaction request message.

The merchant device gateway (102) may transmit (306) the transaction request message to the consumer device gateway (104). The consumer device gateway (104) may receive (308) the transaction request message.

The consumer device gateway (104) may parse the transaction request message and may validate (310) the consumer access code. Validating the consumer access code may include querying a data structure associated with the tag identifier and/or consumer access code and comparing the received consumer access code with a stored consumer access code. Validating the consumer access code may include checking that the merchant device gateway is permitted to transact with the consumer against the tag identifier. In some implementations, the consumer access code may be a cryptographic code and validating the consumer access code may include validating the code using a cryptographic process.

The consumer device gateway (104) may resolve (314) the consumer device (110). Resolving the consumer device may include identifying a consumer device associated with the tag identifier and/or consumer access code. This may include querying the data structure to identify the relevant device to be addressed.

The consumer device gateway (104) may parse (316) the transaction request message to determine actions or information requested therein. Parsing (316) the transaction request message may include evaluating the transaction request message and/or the transaction request detail and transaction information detail. Parsing the transaction request message may include determining whether the transaction is permissible and/or whether any consumer approval or authorisation is required.

If approval (318) is required, the consumer device gateway (104) may transmit (320) an approval request message to the consumer device (110). The approval request message may include information detailing the nature of approval required. The consumer device (110) may receive (322) the approval message and may generate and display an approval prompt message on a display of the consumer device (110) for the consumer to consider and action. The consumer device (110) may receive consumer input either providing or denying approval for the requested transaction and may transmit (324) the consumer input or a message based thereon to the consumer device gateway (104). The consumer device gateway (104) may receive (326) the input and/or message. If the consumer denies approval, the consumer device gateway (104) may terminate or cancel or decline the transaction request.

If approval (318) is not required, or if approval (318) is required and given by the consumer, the consumer device gateway (104) may approve, initiate or otherwise partake in the transaction and/or generate (328) a transaction response message. The course of action taken by the consumer device gateway (104) may depend on the transaction request detail and/or transaction information detail included in the transaction request message received from the merchant device gateway (102).

In some cases, for example, the transaction request detail may include a request for payment by the consumer in favour of the merchant for a particular amount. In such a case, initiating the transaction may include initiating an appropriate financial transaction so as to transfer the amount or a corresponding amount from a financial account associated with the consumer in favour of a financial account associated with the merchant, sharing source of funds data with the merchant device gateway, or the like. It should be appreciated that various types of transactions may be supported, such as payment card-based transactions, electronic funds transfers (EFTs), cryptocurrency-based transactions, wallet-based transactions, and the like. In such a case, generating the transaction response message may include generating a message indicating the status of the requested transaction, such as an indication that the requested transaction has been processed, is pending, has failed or the like. In some cases, generating the transaction response message may include source of funds data in the transaction response message for use by the merchant device gateway in advancing the transaction (e.g. submitting it to a payment network).

In some cases, the transaction request detail may include a list of information about or associated with the consumer that is requested by the merchant device and/or merchant device gateway. In such cases, generating the transaction response message may include compiling one or more data messages including the requested information. Such information may include one or more of the group of: personal information; a billing address; a shipping address; loyalty data; health insurance data; source of funds data; and the like.

The transaction response message may include the tag identifier and/or the consumer access code. The consumer device gateway (104) may transmit (330) the transaction response message to the merchant device gateway (102). The merchant device gateway (102) may receive (332) the transaction response message.

The merchant device gateway (102) may parse the transaction response message and may update (334) a data structure associated with the tag identifier and/or consumer access code. Updating the data structure may include storing information/data included in the transaction response message in the data structure. In some implementations, the data structure may store or reference a transaction status record, and updating the data structure may include updating the transaction status record based on information/data included in the transaction response message. For example, where the transaction response message includes an indication of the status of the requested transaction, updating the transaction status record may include storing the status indication in the status record. For example, the status indication may indicate that an amount of USD20 has been paid by the consumer in favour of the merchant, and the status record may be updated to indicate the payment and an outstanding amount (if any, e.g. in the case of multiple consumers associated with the transaction). In this way, multiple payees may submit payments in association with a single tag identifier.

In some implementations, the merchant device gateway (102) may process or initiate actions based on the transaction response message itself, without forwarding the message or information/data included therein on to the merchant device. The merchant device gateway, may for example use information/data included in the transaction response message to submit a payment request to a payment network, link transaction data with a loyalty identifier, link transaction data with health insurance data, request a health insurer to join the shared session, and the like.

In other implementations, the merchant device gateway (102) may generate and transmit (338) a transaction response message to the merchant device (112). In some cases, the merchant device gateway may forward the transaction response message received from the consumer device gateway (104) to the merchant device while in other cases the merchant device gateway (102) may generate and transmit a new or different transaction response message. The transaction response message transmitted to the merchant device may include all or a subset of the information/data included in the transaction response message received from the consumer device gateway (104).

The merchant device (112) may receive (340) the transaction response message. The merchant device may parse the transaction response message to extract relevant information/data included therein and may proceed accordingly. The merchant device may, for example, use information/data included in the transaction response message to submit a payment request to a payment network, link transaction data with a loyalty identifier, link transaction data with health insurance data, request a health insurer to join the shared session, and the like.

In what follows, an example method for establishing a shared session and conducting a transaction via the shared session is described with reference to an exemplary scenario in which a consumer visits a merchant outlet (116), being a restaurant. The example method is based on the methods described in the foregoing.

The merchant outlet may include a number of tags (118), which may for example be associated with each table at the merchant outlet (116) or the like. It should however be appreciated that aspects of the present disclosure may find application in other bricks-and-mortar implementations as well as in e-commerce implementations in which the consumer does not physically visit the merchant but rather interacts with the merchant electronically, for example by way of a website, mobile application or the like. In such an implementation, the merchant may provide the tag to the consumer via the website, mobile application, etc.

Upon arriving at the merchant outlet (116), the consumer may use his or her consumer device (110) to obtain, access or capture a tag identifier from the tag (118) and transmit the tag identifier to the consumer device gateway in a shared session request message (e.g. as described above with reference to FIG. 3). In this example scenario, the tag may be associated with the table at which the consumer is seated.

The merchant device (112) may in turn transmit a shared session request message at some stage, which may include the tag identifier and other information/data, to the merchant device gateway (102). The merchant device gateway (102) may receive the shared session request message including the tag identifier from the merchant device. The merchant device gateway (102) may validate the tag identifier received in the shared session request message received from the merchant device (112). If the tag identifier received in the shared session request message received from the merchant matches the stored tag identifier, the merchant device gateway (102) may add or join the merchant device (112) to the shared session.

The consumer may now be in a joint session with the merchant where various messages can be exchanged without necessarily disclosing the consumer's identity. In some implementations, the tag identifier may be associated with a pre-authorised status (e.g. as described above with reference to FIG. 4). Once a shared session has been established between the consumer and the merchant, one or more of a number of processes may follow. For example, and as elaborated on below, once the “check-in” has been effected, or the shared session established, the merchant may be able to issue a payment request, loyalty identifier request, loyalty enrollment request or the like. For example, in some cases, the merchant device (112), knowing that the tag identifier has been provided to the consumer, may initiate an information exchange with the consumer device (110), via the relevant device gateways. The information exchange may be via the shared session.

At some stage, the consumer may initiate or enter into a transaction with the merchant (or vice versa). In an e-commerce scenario this may be achieved by proceeding to checkout, while in a bricks-and-mortar scenario this may include the goods/services which the consumer wishes to purchase being entered into a point of sale device (which may be the merchant device (112) and being totalled for payment. In the case of the exemplary restaurant scenario, the consumer may have decided on and ordered a meal. Ordering may be via an employee employed at the merchant outlet (116) or may be via the consumer device (110).

Establishing the shared session may occur prior to any transaction (or commitment to transact). It may for example be performed upon arrival at a merchant (physically, or by logging on to a website), whether or not a transaction is to be conducted. In any case, as mentioned, at some stage, the consumer may initiate or enter into or initiate a transaction with the merchant. In an e-commerce scenario this may be achieved by proceeding to checkout, while in a bricks-and-mortar scenario this may include the goods/services which the consumer wishes to purchase being entered into a point of sale device (which may be the merchant device (112)) and being totalled for payment. The transaction is not necessarily a financial transaction, and may involve another type of exchange (e.g. the exchange of personal information or the like).

With reference to the exemplary restaurant scenario, for example, a transaction request message may be transmitted to the merchant device gateway (102) once the consumer has finished his or her meal at the merchant outlet (116). For example, upon completion of the meal, the consumer may request the bill or check representing the total amount owed by the consumer for the meal. The consumer may approve the amount and may add a tip to arrive at an increased amount. The consumer may indicate that he or she wishes to pay using the system described herein in response to which a service assistant (or the consumer him/herself) may input the amount (or increased amount) and tag the identifier into the merchant device (112) for transmission to the merchant device gateway (102). The tag identifier may be input into the consumer device (110) in the same way that it is captured by the consumer device (110). In other cases, the tag identifier may be associated with a table number which may be input into the merchant device (112). It should be appreciated that receipt of the transaction request message may succeed, or follow, initiation of the transaction between the consumer and the merchant. In other words, the transaction request message may be received after the transaction has been initiated, and in some cases, once payment in respect of the transaction is due. Receiving the payment request message may establish or confirm an obligation by the consumer to make payment in respect of the amount in favour of the merchant. The merchant device gateway (102) may determine whether the transaction request message is associated with a tag identifier which matches the tag identifier associated with the pre-authorised status. The merchant device gateway (102) may for example extract a tag identifier from the transaction request message and query the data structure for a matching tag identifier. If the tag identifier received in association with the transaction request message matches the store tag identifier, and if the transaction request message is a payment request message, the merchant device gateway (102) may automatically initiate processing a payment in respect of the amount without consumer intervention. Initiating processing of the payment may include the merchant device gateway (102) forwarding the transaction request message to the consumer device gateway (104). The consumer device gateway (104) may receive the transaction request message and evaluate the amount received in the payment request message against the pre-authorised limit stored in association with the stored tag identifier. As mentioned above, in some cases, the stored tag identifier may be associated with multiple pre-authorisation statuses. In such a case, evaluating the amount may include evaluating the amount against a pre-authorised limit associated with each of the pre-authorised statuses. If the amount is less than or equal to the pre-authorised limit, the consumer device gateway (104) may automatically process a payment in respect of the amount without consumer intervention. If the amount is greater than the pre-authorised limit, the consumer device gateway (104) may prompt the consumer for authorisation to process the payment in respect of the amount via the consumer device (110). In some embodiments, prompting the consumer may include the consumer device gateway (104) transmitting an authorisation request message to the consumer device (110) (e.g. using a communication address stored in association with the tag identifier). In other cases, other authorisations may be requested. For example in some cases a merchant may request sensitive personal information and the consumer may be prompted to authenticate provision of such information. The message may include the amount in respect of the transaction and merchant details and may be configured to prompt the consumer for authorisation to process the payment in respect of the amount. For example, the message may be configured to display a prompt on a display of the consumer device (110) requesting input as to whether or not the payment may be processed. The consumer device (110) may receive and display the authorisation request message on a display associated therewith. The consumer device (110) may receive consumer input as to the authorisation or otherwise of the payment and may transmit a transaction response message to the consumer device gateway (104). The transaction response message may include the consumer input as to whether or not payment of the amount is authorised. The consumer device gateway (104) may receive the transaction response message from the consumer device. If the transaction response message denies authorisation, the consumer device gateway (104) may decline the payment request. If the authorisation response message confirms authorisation, the consumer device gateway (104) may process the payment in respect of the amount without further consumer intervention. In other embodiments, the merchant device gateway (102) may receive the authorisation response message from the consumer device (110) via the consumer device gateway (104). Processing the payment may include instructing payment of the amount against a financial account associated with the consumer in favour of a financial account associated with the merchant. Processing the payment may include accessing details of a financial account associated with the merchant and initiating a payment for the amount against the financial account associated with the consumer in favour of the financial account associated with the merchant. Once payment has been processed, payment confirmation notification messages may be transmitted to one or more of the consumer device (110), the merchant device gateway (102) and the merchant device (112). Similarly, if processing of the payment fails, payment failure notification messages may be transmitted.

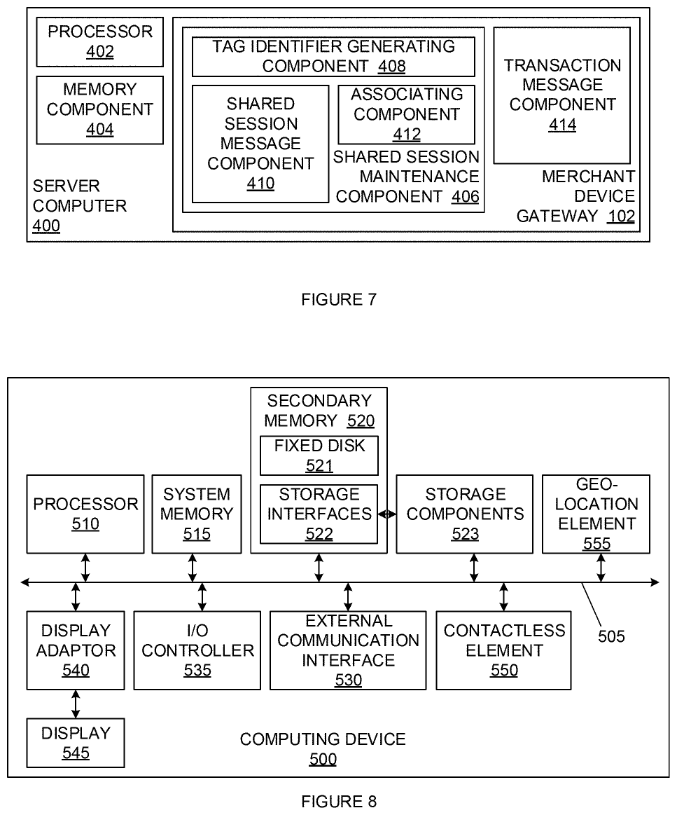

Various components of a system may be provided for implementing the methods described above. FIG. 7 is a block diagram which illustrates some exemplary components which may be provided by a system for establishing and transacting via a shared session according to aspects of the present disclosure. While only some components are illustrated and described, it should be appreciated that further components may be provided as may be necessary to implement described methods. The system may include a server computer (400).

The server computer (400) may include a processor (402) for executing the functions of components described below, which may be provided by hardware or by software units executing on the server computer (400). The software units may be stored in a memory component (404) and instructions may be provided to the processor (402) to carry out the functionality of the described components.

The server computer (400) may include or provide a merchant device gateway (102). In some implementations, the server computer may include or provide a consumer device gateway (104) as well, while in other implementations the consumer device gateway may be provided by another server computer which may be under the control of another entity.

The server computer (400) may include a shared session maintenance component (406) for initiating, maintaining and closing a shared session. The shared session may be configured for requesting and providing transaction-related data by and to at least one of the devices associated with the shared session.

The shared session maintenance component (406) may include a tag identifier generating component (408) for generating a tag identifier to be associated with the shared session.

The shared session maintenance component (406) may include a shared session message component (410). The shared session message component may be configured to transmit and/or receive shared session request messages and/or shared session response messages. The shared session message component may be configured to receive shared session request messages from one or both of the merchant device (112) and the consumer device gateway (104). The shared session message component may be configured to transmit shared session response messages to one or both of the merchant device (112) and the consumer device gateway (104).

In some implementations, the server computer (400) may include a pre-authorisation confirmation message receiving component which may be arranged to receive a pre-authorisation confirmation message. The pre-authorisation confirmation message may be associated with a tag identifier having been obtained by a consumer device from a tag provided to the consumer by a merchant. The tag identifier may be associated with a transaction to be conducted between the merchant and a consumer associated with the consumer device.

The shared session maintenance component (406) may include an associating component (412). The associating component may be configured to associate one or more of the consumer device, consumer gateway device and merchant device, with a shared session. Associating devices with the shared session may include storing access codes assigned to the relevant devices in a data structure associated with a tag identifier. The access codes may be used by device gateways to control access to and exchanges with records or information associated with their respective devices.

In some implementations, the associating component (412) may be arranged to associate the tag identifier and/or shared session with a pre-authorised status. This may include storing the tag identifier in a data structure in association with the pre-authorised status.

The server computer (400) may include a transaction message component (414) configured to transmit and/or receive transaction request messages and/or transaction response messages. The transaction request messages and transaction response messages may be communicated via the shared session.

The server computer (400) may include a payment request message receiving component which may be arranged to receive a payment request message. The payment request message may be received from a merchant device, may be associated with the tag identifier, and may include an amount in respect of the transaction.

The server computer (400) may include a payment processing component which may be arranged to automatically initiate processing a payment in respect of the amount without consumer intervention. The payment processing component may process the payment if the tag identifier associated with the payment request message matches the tag identifier associated with the pre-authorised status and in some cases subject to other predefined conditions.

Aspects of the present disclosure may enable a user to obtain a merchant generated token (e.g. the tag identifier) linked to a merchant transaction by retrieving it from a pre-setup application and using it to register their interest in sharing and interacting with the merchant. The merchant may then be able to request information from the end user via a third party, allowing the user to share only a limited set of information with that end user (merchant).

FIG. 8 illustrates an example of a computing device (500) in which various aspects of the disclosure may be implemented. The computing device (500) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant, or the like. Different embodiments of the computing device may dictate the inclusion or exclusion of various components or subsystems described below.

The computing device (500) may be suitable for storing and executing computer program code. The various participants and elements in the previously described system diagrams may use any suitable number of subsystems or components of the computing device (500) to facilitate the functions described herein. The computing device (500) may include subsystems or components interconnected via a communication infrastructure (505) (for example, a communications bus, a network, etc.). The computing device (500) may include one or more processors (510) and at least one memory component in the form of computer-readable media. The one or more processors (510) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (500) may be distributed over a number of physical locations (e.g. in a distributed, cluster or cloud-based computing configuration) and appropriate software units may be arranged to manage and/or process data on behalf of remote devices.

The memory components may include system memory (515), which may include read only memory (ROM) and random access memory (RAM). A basic input/output system (BIOS) may be stored in ROM. System software may be stored in the system memory (515) including operating system software. The memory components may also include secondary memory (520). The secondary memory (520) may include a fixed disk (521), such as a hard disk drive, and, optionally, one or more storage interfaces (522) for interfacing with storage components (523), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (500) may include an external communications interface (530) for operation of the computing device (500) in a networked environment enabling transfer of data between multiple computing devices (500) and/or the Internet. Data transferred via the external communications interface (530) may be in the form of signals, which may be electronic, electromagnetic, optical, radio, or other types of signal. The external communications interface (530) may enable communication of data between the computing device (500) and other computing devices including servers and external storage facilities. Web services may be accessible by and/or from the computing device (500) via the communications interface (530).

The external communications interface (530) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (530) may include a subscriber identity module (SIM) in the form of an integrated circuit that stores an international mobile subscriber identity and the related key used to identify and authenticate a subscriber using the computing device (500). One or more subscriber identity modules may be removable from or embedded in the computing device (500).

The external communications interface (530) may further include a contactless element (550), which is typically implemented in the form of a semiconductor chip (or other data storage element) with an associated wireless transfer element, such as an antenna. The contactless element (550) may be associated with (e.g., embedded within) the computing device (500) and data or control instructions transmitted via a cellular network may be applied to the contactless element (550) by means of a contactless element interface (not shown). The contactless element interface may function to permit the exchange of data and/or control instructions between computing device circuitry (and hence the cellular network) and the contactless element (550). The contactless element (550) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (500) and an interrogation device. Thus, the computing device (500) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (510). A computer program product may be provided by a non-transient computer-readable medium, or may be provided via a signal or other transient means via the communications interface (530).

Interconnection via the communication infrastructure (505) allows the one or more processors (510) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (500) either directly or via an I/O controller (535). One or more displays (545) (which may be touch-sensitive displays) may be coupled to or integrally formed with the computing device (500) via a display (545) or video adapter (540).

The computing device (500) may include a geographical location element (555) which is arranged to determine the geographical location of the computing device (500). The geographical location element (555) may for example be implemented by way of a global positioning system (GPS), or similar, receiver module. In some implementations the geographical location element (555) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (500). In some implementations, the geographical location element (555) may implement inertial navigation to track and determine the geographical location of the computing device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims. Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method conducted at a first device gateway comprising:
receiving a first shared session request message being associated with a tag identifier and a first device associated with a first entity;
associating the first device with a shared session associated with the tag identifier;
receiving, from a second device associated with a second entity, via a second device gateway, a second shared session request message, the second shared session request message including the tag identifier; and
associating the second device with the shared session,
wherein one or both of the first device and the second device having obtained the tag identifier from a tag provided by the first entity or the second entity, and
wherein the shared session is configured for requesting and providing transaction-related data.

2. The method as claimed in claim 1, wherein associating the first device or the second device with the shared session includes initiating a shared session in association with the tag identifier and the first device or the second device.

3. The method as claimed in claim 1, including validating the tag identifier received from the first device or the second device.

4. The method as claimed in claim 3, wherein validating the tag identifier includes checking a list or data structure for a matching tag identifier.

5. The method as claimed in claim 3, wherein the tag identifier is a cryptographic code configured for validation using a cryptographic process, and wherein validating the tag identifier includes using the cryptographic process to validate the tag identifier.

6. The method as claimed in claim 1, including receiving a first transaction request message, including the tag identifier, from one of the first device or the second device and transmitting a second transaction request message, including the tag identifier, to the other of the second device or the first device, wherein the second transaction request message is based on the first transaction request message.

7. The method as claimed in claim 1, wherein the first device gateway communicates with the second device gateway via a communication network, wherein the first shared session request message is a request to initiate the shared session, and wherein the method includes generating the tag identifier and transmitting the tag identifier to the first device.

8. The method as claimed in claim 7, including assigning a first access code to the first device, and wherein the tag identifier and the first access code are transmitted to the first device in a shared session response message.

9. The method as claimed in claim 7, wherein the second shared session request message includes a second access code.

10. The method as claimed in claim 9, including storing the second access code in association with the tag identifier.

11. The method as claimed in claim 7, the second device having obtained the tag identifier from the tag provided by the first entity.

12. The method as claimed in claim 9, including transmitting, via the shared session, a transaction request message to the second device gateway, the transaction request message including the tag identifier, the second access code and one or both of transaction request detail and transaction information detail.

13. The method as claimed in claim 12, wherein the transaction request message transmitted to the second device gateway is based on a transaction request message received from the first device.

14. The method as claimed in claim 12, including receiving, via the shared session, a transaction response message from the second device gateway, the transaction response message including one or both of information requested by way of the transaction request detail and a confirmation of actions initiated in respect of the transaction request detail.

15. The method as claimed in claim 1, wherein the first entity is a merchant and the second entity is a consumer.

16. A system comprising a processor and a memory configured to provide computer program instructions to the processor to execute functions of components, the system including a first device gateway including:
a shared session message component for receiving a first shared session request message being associated with a tag identifier and a first device associated with a first entity;
an associating component for associating the first device with a shared session associated with the tag identifier;
the shared session message component further being for receiving, from a second device associated with a second entity, via a second device gateway, a second shared session request message, the second shared session request message including the tag identifier; and
the associating component further being for associating the second device with the shared session,
wherein one or both of the first device and the second device having obtained the tag identifier from a tag provided by the first entity or the second entity, and
wherein the shared session is configured for requesting and providing transaction-related data.

17. A computer program product comprising a computer-readable medium having stored computer-readable program code for performing, at a first device gateway, the steps of:
receiving a first shared session request message being associated with a tag identifier and a first device associated with a first entity;
associating the first device with a shared session associated with the tag identifier;
receiving, from a second device associated with a second entity, via a second device gateway, a second shared session request message, the second shared session request message including the tag identifier; and
associating the second device with the shared session,
wherein one or both of the first device and the second device having obtained the tag identifier from a tag provided by the first entity or the second entity, and
wherein the shared session is configured for requesting and providing transaction-related data.

18. The method as claimed in claim 1, wherein the second shared session request message includes data usable by the second device gateway for controlling requests for information from other entities.

19. The method as claimed in claim 1, wherein the tag identifier includes information usable in identifying the first device gateway.

20. The method as claimed in claim 1, wherein the shared session is initially independent of any transaction, wherein the shared session is a digital communication conduit via which entities can exchange data pursuant to entering into and completing a transaction.

21. The method as claimed in claim 12, wherein the transaction request detail includes a list of information about or associated with the second entity that is requested by one or both of the first device and first device gateway, including one or more of the group of: personal information; a billing address; a shipping address; loyalty data; health insurance data; and, source of funds data.
